(19) United States
(12) Patent Application Publication
(10) Pub. No.: US 2017/0233029 A1
(43) Pub. Date: Aug. 17, 2017

(54) PRESS-FIT DEVICE FOR BICYCLE STEM

(71) Applicant: Mu-Rong Li, TAICHUNG CITY (TW)

(72) Inventor: Mu-Rong Li, TAICHUNG CITY (TW)

(21) Appl. No.: 15/046,408

(22) Filed: Feb. 17, 2016

(51) Int. Cl. B62K 21/18

(52) U.S. Cl. CPC B62K 21/18

(57) ABSTRACT

A press-fit device for bicycle stein comprises a main body and two press-fit sets. The main body has a front-fork hole and a handlebar hole arranged at two ends thereof respectively. The front-fork hole and the handlebar hole have a receiving groove respectively for fluidly communicating therewith. Each press-fit set includes a driving block which has a first inclined guiding surface and a through hole with inner threads for passing through the first inclined guiding surface. A guiding block has a second inclined guiding surface and a guiding hole for passing through the second inclined guiding surface. The first and the second inclined guiding surfaces are respectively formed a tapered side and a divergent side. A press-fit block includes a trepanning hole and two inclined end surfaces. A press-fit screw is passed through the guiding hole and the trepanning hole and screwed with the inner threads.

### BACKGROUND OF THE INVENTION

1. Field of the Invention

The present invention relates to a bicycle, and especially relates to a press-fit device for bicycle stein capable for assembling and installing the handlebar and the front fork.

2. Description of Related Art

Please reference to Taiwanese patent no. M376503 (hereafter '503), it disclosed a handlebar tightening structure for bicycle handlebar stein. A front-fork receiving groove is arranged at one end of a stein body and a handlebar receiving groove is arranged at the other end of the stein body. The structure comprises an assembly seat, a notched groove, and a front cover seat. The assembly seat is integrally formed with the stein body and an arc concave groove is formed thereof. The angle of the notched groove corresponding to the center of the arc concave groove is less than 90 degree. The front cover seat is covered on the assembly seat so as to form the handlebar receiving groove. The concave groove of the assembly seat cooperates with a positioning member which is passed through to lock and connect the front cover seat and the assembly seat so that the contact area is larger and the coverage is better. At the same time, the straining force is stronger for providing to assemble to the outer diameter of the handlebar with various-shaped or designed shape pipe. It may be convenient and fastened tightly while assembling.

However, please refer to the handlebar tightening structure for bicycle handlebar stein in FIGS. 2 to 5 of '503. Two sets of ear portions with a positioned hole are respectively arranged at two sides of the opening of the arc concave groove. Two ear portions are cooperated with the positioning members to respectively assemble to the connection holes arranged at two ends of the two front cover seats. Because there are numerous elements, the processing and assembling before using are more complicated. The handlebar may be fastened firmly with complicated assembly. It may make the assembly more difficult.

When the above mentioned structure with numerous elements must angularly adjust to connect, many screws must be screwed out first and then the screws must be screwed in one by one after adjusting to provide to use again. It is inconvenient for using.

Please also reference to Taiwanese patent no. M396249 (hereafter '249), it disclosed a fastening structure for a handle stein. A front-fork receiving groove and a handlebar receiving groove are respectively arranged at two ends of a stein body. The structure comprises an assembly seat and a cover body. The assembly seat is arranged at one end of the stein body and an first concave groove with arc shape is formed thereof. Four through holes are respectively arranged at each corner of the assembly seat. An angle θ is formed between the axle of the stein body and the left through hole or the right through hole. An angle θ′ is formed between the center of the first concave groove and the upper through hole or the lower through hole. The cover body has a second concave groove. Four positioning holes are arranged on the cover body and corresponding to the four through holes. A plurality of positioning members may be passed through and lock the assembly seat the cover body so that the straining force of each positioning member may be evenly distributed to the cover body to improve the effects of pressing-fit handlebar and positioning firmly.

Although the above mentioned cover body of the fastening structure is integrated to a single structure, there are four through holes and four positioning holes arranged between the assembly seat and the cover body. When the above mentioned structure must angularly adjust to connect, many screws must be screwed out first and then the screws must be screwed in one by one after adjusting to provide to use again. It is inconvenient for using.

In conclusion, the above mentioned fastening device for bicycle stein has some drawbacks described as follows.

Firstly, there are numerous elements to result in more complicated processing and assembling before using. The handlebar may be fastened firmly with complicated assembly. It may make the assembly more difficult.

Secondly, when the above mentioned structure with numerous elements must angularly adjust to connect, many screws must be screwed out first and then the screws must be screwed in one by one after adjusting to provide to use again while installing and calibrating. It is inconvenient for using.

In view of the foregoing circumstances, the inventor has invested a lot of time to study the relevant knowledge, compare the pros and cons, research and develop related products. After quite many experiments and tests, the “press-fit device for bicycle stein” of this invention is eventually launched to improve the foregoing shortcomings, to meet the public use.

### SUMMARY OF THE INVENTION

A main object of this invention is providing a press-fit device for bicycle stein. the front fork and the handlebar may be quickly pressed-fit tightly to assemble so as to simplify the structure and manufacture more quickly through the press-fit screw with one-time screwing operation.

Another object of this invention is providing a press-fit device for bicycle stein. the front fork and the handlebar may be pressed-fit to fasten or released so as to adjust for each operation while installation and calibration through the press-fit screw with one-time screwing operation.

In order to achieve above mentioned objects, a press-fit device for bicycle stein comprises a main body, having a front-fork hole and a handlebar hole arranged at two ends thereof respectively, and the front-fork hole and the handlebar hole have a receiving groove respectively for fluidly communicating therewith; and two press-fit sets, respectively arranged at the receiving groove fluidly communicated with the front-fork hole and the receiving groove fluidly communicated with the handlebar hole, each press-fit set includes a press-fit block, a driving block, a guiding block, and a press-fit screw, the driving block has a first inclined guiding surface and a through hole for passing through the first inclined guiding surface, the through hole has inner threads, the guiding block has a second inclined guiding surface and a guiding hole for passing through the second inclined guiding surface, the first inclined guiding surface and the second inclined guiding surface are formed a tapered side toward the corresponding receiving groove and a divergent side opposite to the tapered side, the press-fit block includes a trepanning hole, a press-fit surface, and two inclined end surfaces respectively corresponding to the first inclined guiding surface and the second inclined guiding surface, a diameter of the trepanning hole is larger than a diameter of the press-fit screw and passed through the two end surfaces, the press-fit screw is passed through the guiding hole and the trepanning hole and screwed with the inner threads of the driving block, the press-fit screw is screwed in so that the first inclined guiding surface and the second inclined guiding surface are respectively pressed-fit the two end surfaces of the press-fit block, the press-fit surface of the press-fit block is moved toward the font-fork hole and then pressed-fit a font fork and moved toward to handlebar hole to press-fit a handlebar, and the press-fit screw is screwed out so that the press-fit surface of the press-fit block is moved reversely to release.

In some embodiments, a step groove is concavely arranged at the main body for fluidly communicating with the front-fork hole and an upper end of the receiving groove fluidly communicated with the front-fork hole.

In some embodiments, a support plate is arranged at a lower end of the receiving groove fluidly communicated with the front-fork hole and extended toward the front-fork hole to support the driving block.

In some embodiments, the main body has an upper cover for covering the step groove, the upper cover has two operation holes respectively corresponding to the front-fork hole and the press-fit screw.

In some embodiments, one side of each press-fit block opposite to the press-fit surface has an arc connection surface corresponding to an inner wall of the corresponding receiving groove.

In some embodiments, the guiding block has a step hole arranged at the guiding hole for receiving a head portion of the press-fit screw.

In some embodiments, an axial direction of the front-fork hole is corresponding to a longitudinal direction of the main body, an axial direction of the handlebar hole is corresponding to a lateral direction of the main body, the receiving groove fluidly communicated with the front-fork hole and the receiving groove fluidly communicated with the handlebar hole are arranged adjacent to the connection of the front-fork hole and the handlebar hole.

The various objects and advantages of the present invention will be more readily understood from the following detailed description when read in conjunction with the appended drawing.

### BRIEF DESCRIPTION OF THE DRAWINGS

FIG. 1 is an exploded view of a press-fit device for bicycle stein of the present invention;

FIG. 2 is a structural view of the press-fit set of the present invention whose first inclined guiding surface and the second inclined surface are formed a tapered side and a divergent side respectively;

FIG. 3 is a perspective view of the press-fit device for bicycle stein of the present invention;

FIG. 4 is a cross-sectional view of FIG. 3 along line IV-IV;

FIG. 5 is an operational view of the press-fit set which is pressed-fit the handlebar; and

FIG. 6 is a cross-sectional view of FIG. 3 along line VI-VI.

### DETAILED DESCRIPTION OF THE INVENTION

To describe clearly that the present invention achieves the foregoing object and function, the technical features and desired function are described with reference to a preferred embodiment and accompanying drawings.

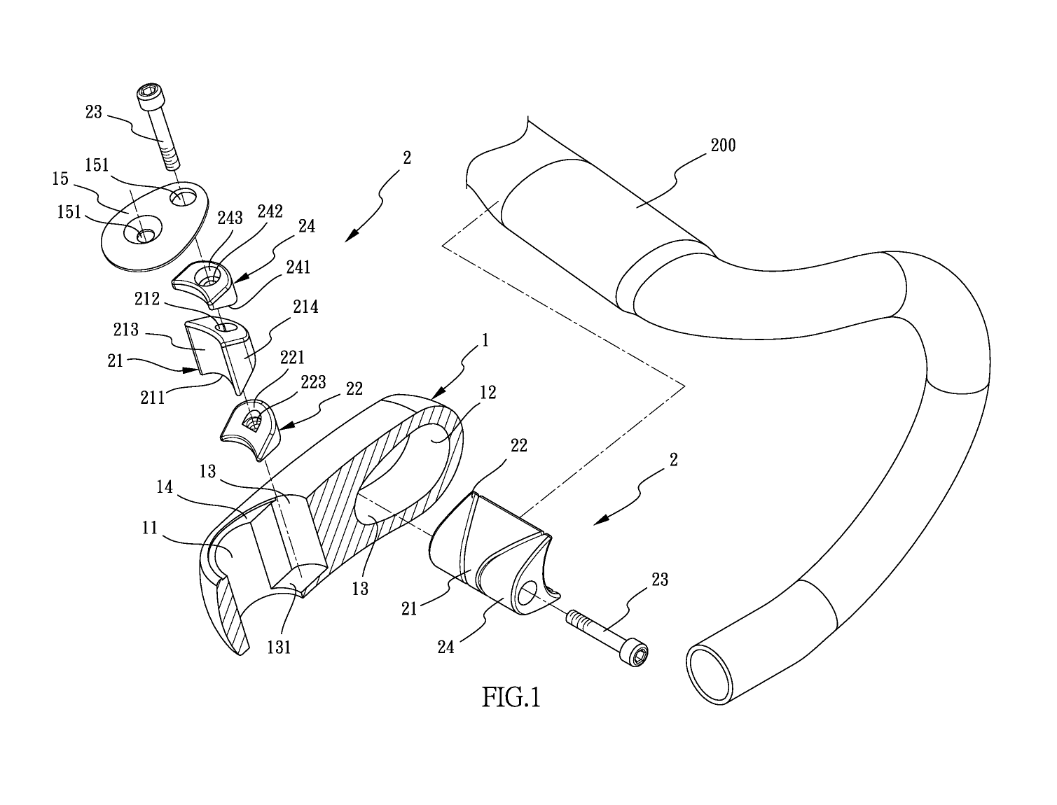

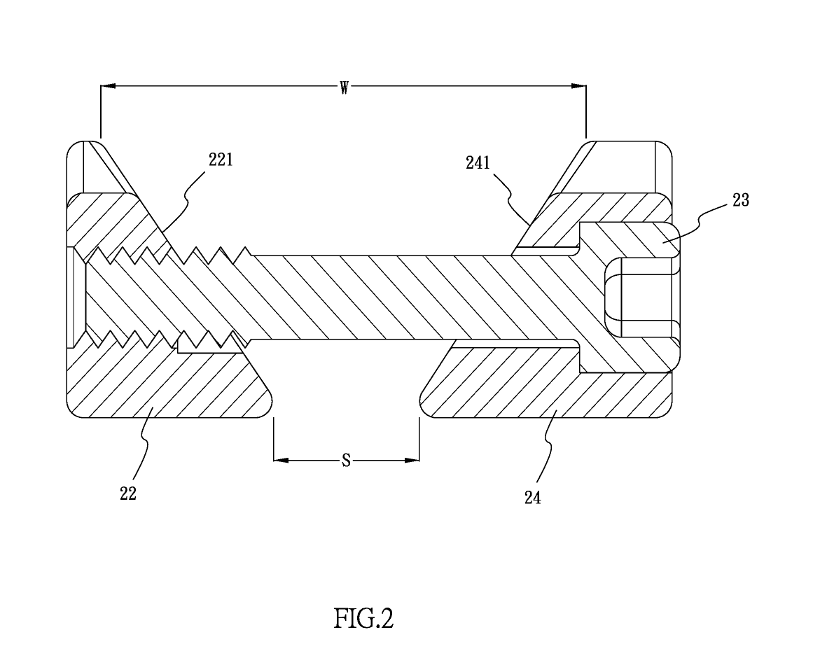

Please reference to FIGS. 1 to 4, a press-fit device for bicycle stein of the present invention may comprise a main body 1 and two press-fit sets 2.

The main body 1 may have a front-fork hole 11 and a handlebar hole 12 which are arranged at two ends of the main body 1 respectively. The front-fork hole 11 and the handlebar hole 12 each has a receiving groove 13 respectively for fluidly communicating therewith. And the receiving groove 13 fluidly communicated with the front-fork hole 11 and the receiving groove 13 fluidly communicated with the handlebar hole 12 are arranged adjacent to the connection of the front-fork hole 11 and the handlebar hole 12.

The two press-fit sets 2 may be respectively arranged at the receiving groove 13 fluidly communicated with the front-fork hole 11 and the receiving groove 13 fluidly communicated with the handlebar hole 12. Each press-fit set 2 may include a press-fit block 21, a driving block 22, a guiding block 24, and a press-fit screw 23. The driving block 22 has a first inclined guiding surface 221 and a through hole 223 for passing through the first inclined guiding surface 221. The through hole 223 has inner threads 224. The guiding block 4 has a second inclined guiding surface 241 and a guiding hole 242 for passing through the second inclined guiding surface 241. The first inclined guiding surface 221 and the second inclined guiding surface 241 are formed a tapered side S toward the corresponding receiving groove 13 and a divergent side W opposite to the tapered side S. The press-fit block 21 includes a trepanning hole 212, a press-fit surface 213, and two inclined end surfaces 211 respectively corresponding to the first inclined guiding surface 221 and the second inclined guiding surface 241. A diameter of the trepanning hole 212 is larger than a diameter of the press-fit screw 23 and passed through the two end surfaces 211. The press-fit screw 23 is passed through the guiding hole 232 and the trepanning hole 212 and screwed with the inner threads 224 of the driving block 22. The press-fit screw 23 is screwed in so that the first inclined guiding surface 221 and the second inclined guiding surface 241 are respectively pressed-fit the two end surfaces 211 of the press-fit block 21. The press-fit surface 213 of the press-fit block 21 is moved toward the font-fork hole 11 and then pressed-fit a font fork 100 and moved toward to handlebar hole 12 to press-fit a handlebar 200. The press-fit screw 23 is screwed out so that the press-fit surface 213 of the press-fit block 21 is moved reversely to release.

The above mentioned embodiment is the main skill feature of this invention and corresponds to the claim 1 of this invention to understand the object and embodiments of this invention in detail. And the skill features of the depending claims are for describing the claim 1 in detail or adding more skill features, but not limited thereto. It should be known that the claim 1 is not necessary to include the skill features of the depending claims.

In FIGS. 1 to 4, a step groove 14 is concavely arranged at the main body 1 and fluidly communicated with an upper end of the front-fork hole 11 and an upper end of the receiving groove 13 fluidly communicated with the front-fork hole 11. Additionally, a support plate 131 is arranged at a lower end of the receiving groove 13 fluidly communicated with the front-fork hole 11 and extended toward the front-fork hole 11 to support the driving block 22. The main body 1 has an upper cover 15 for covering the step groove 14. The upper cover 15 has two operation holes 151 respectively corresponding to the front-fork hole 11 and the press-fit screw 23. One side of each press-fit block 21 opposite to the press-fit surface 213 has an arc connection surface 214 which is corresponding to an inner wall of the corresponding receiving groove 13. The guiding block 24 has a step hole 243 arranged at the guiding hole 242 for receiving a head portion of the press-fit screw 23. An axial direction of the front-fork hole 11 is corresponding to a longitudinal direction of the main body 1. An axial direction of the handlebar hole 12 is corresponding to a lateral direction of the main body 1. The receiving groove 13 fluidly communicated with the front-fork hole 11 and the receiving groove 13 fluidly communicated with the handlebar hole 12 are arranged adjacent to the connection of the front-fork hole 11 and the handlebar hole 12.

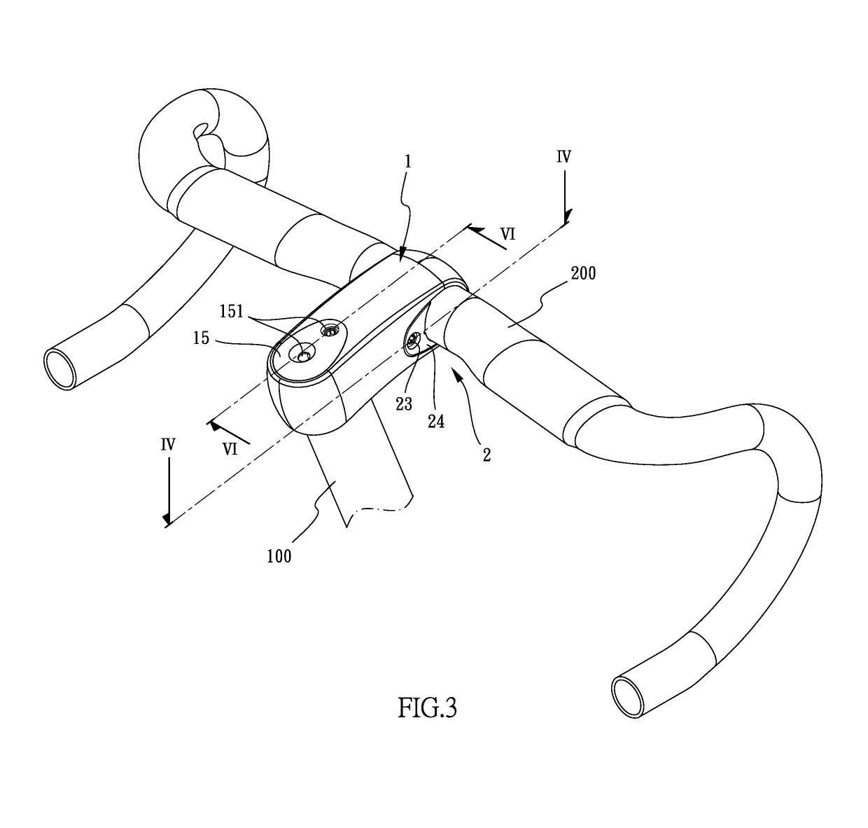

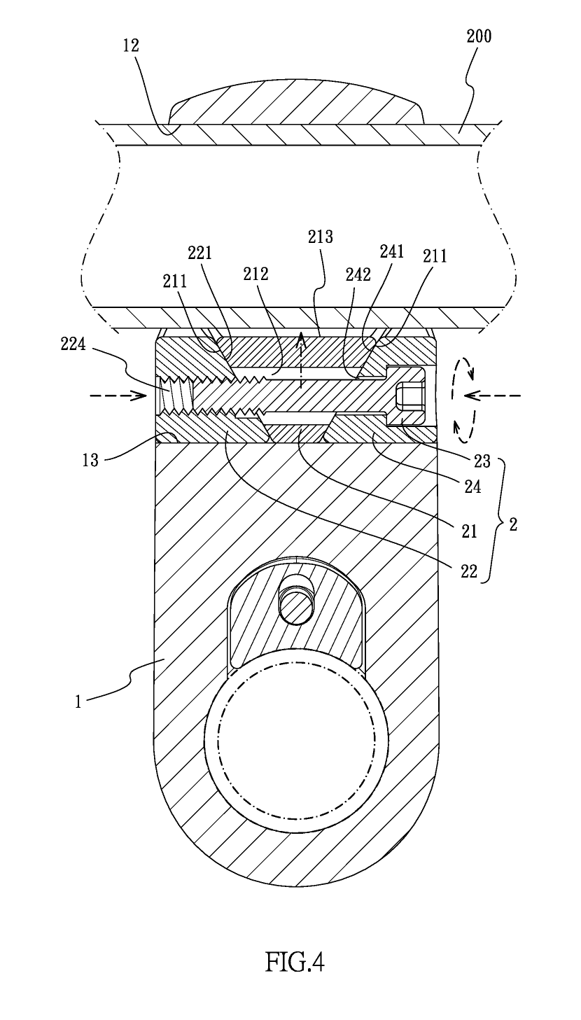

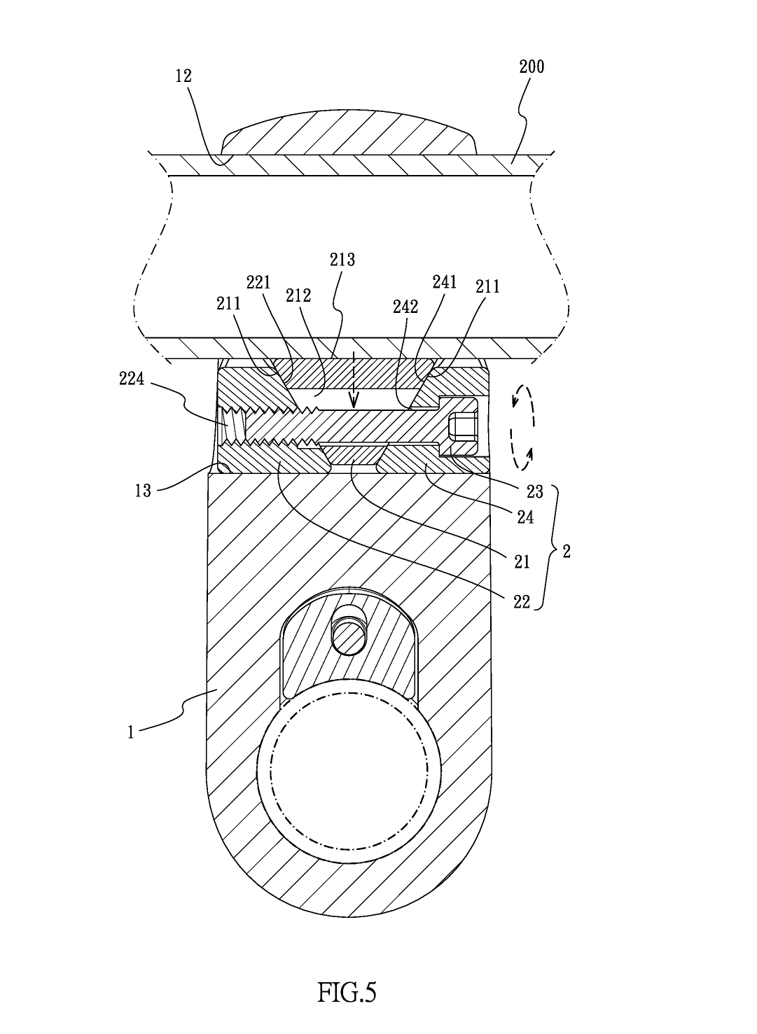

FIG. 4 is a cross-sectional view of FIG. 3 along line IV-IV. The press-fit set 2 installed to the receiving groove 13 fluidly communicated with the handlebar hole 12 is operated to press-fit the handlebar 200. That is, the press-fit screw 23 is passed through the guiding hole 242 and the trepanning hole 212 and screwed with the inner threads 224 of the driving block 22. When the press-fit screw 23 is screwed in along the direction of the dashed-line arrow in FIG. 4, the first inclined guiding surface 221 and the second inclined guiding surface 241 are respectively pressed-fit the two end surfaces 211 of the press-fit block 21. The press-fit surface 213 of the press-fit block 21 is moved toward the handlebar hole 12 and a part of the handlebar 200 installed in the handlebar hole 12 is pressed-fit tightly, shown as in FIG. 5. On the contrary, when the press-fit screw 23 is screwed out along the direction of the dashed-line arrow in FIG. 5, the press-fit surface 213 of the press-fit block 21 is moved reversely to release. That is, the press-fit screw 23 is screwed with one-time operation so that the part of the handlebar 200 installed in the handlebar hole 12 may be quickly assembled to press-fit tightly. It may make the manufacture and assembly more quickly. When the adjustment is needed in the operations of installation and calibration, the press-fit screw 23 may be also screwed with one-time operation so that the handlebar 200 may be pressed-fit tightly and released to do each adjusting operation in use to achieve the convenience in use.

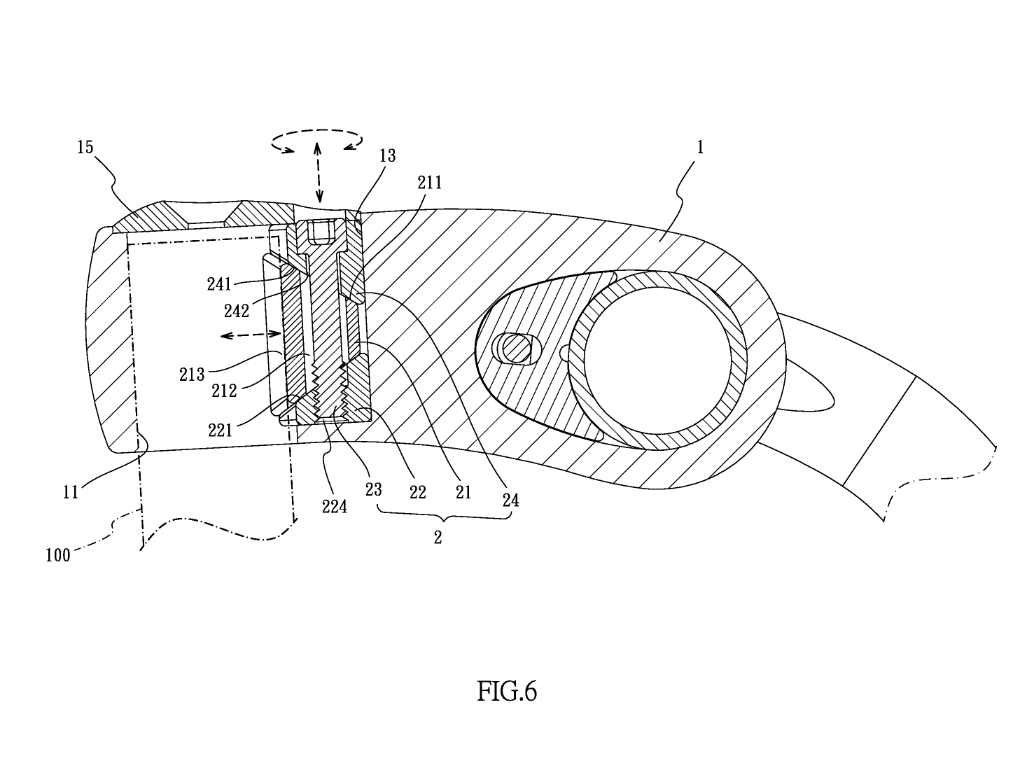

FIG. 6 is a cross-sectional view of FIG. 3 along line VI-VI. The press-fit set 2 installed to the receiving groove 13 fluidly communicated with the front-fork hole 11 is operated to press-fit the front fork 100. That is, the press-fit screw 23 is passed through the guiding hole 242 and the trepanning hole 212 and screwed with the inner threads 224 of the driving block 22. The press-fit screw 23 is screwed in or out along the direction of the dashed-line arrow in FIG. 6, the first inclined guiding surface 221 and the second inclined guiding surface 241 are pressed-fit or released the two end surfaces 211 so that the press-fit surface 214 of the press-fit block 21 is moved toward the divergent side W or the tapered side S. A part of the front fork 100 installed in the front-fork hole 11 may be operated to press-fit ore release. That is, the press-fit screw 23 is screwed with one-time operation so that the part of the front fork 100 installed in the front-fork hole 11 may be quickly assembled to press-fit tightly. It may make the manufacture and assembly more quickly. When the adjustment is needed in the operations of installation and calibration, the press-fit screw 23 may be also screwed with one-time operation so that the front fork 100 may be pressed-fit tightly and released to do each adjusting operation in use to achieve the convenience in use.

As above mentioned, the front-fork hole 11 and the handlebar hole 12 respectively arranged at two ends of the main body 1 are respectively using a single press-fit screw 23 to pass through the guiding block 24 and the press-fit block 21 and screwed with the inner threads 224 of the driving block 22 which are formed a structure of the press-fit sets 2 so as to truly improve the drawbacks of the prior art. There are some advantages for the present invention described as follows.

Firstly, the front fork 100 and the handlebar 200 may be quickly pressed-fit tightly to assemble so as to simplify the structure and manufacture more quickly through the press-fit screw 23 with one-time screwing operation.

Secondly, the front fork 100 and the handlebar 200 may be pressed-fit to fasten or released so as to adjust for each operation while installation and calibration through the press-fit screw 23 with one-time screwing operation.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A press-fit device for bicycle stein, comprising:
a main body, having a front-fork hole and a handlebar hole arranged at two ends thereof respectively, and the front-fork hole and the handlebar hole have a receiving groove respectively for fluidly communicating therewith; and
two press-fit sets, respectively arranged at the receiving groove fluidly communicated with the front-fork hole and the receiving groove fluidly communicated with the handlebar hole, each press-fit set includes a press-fit block, a driving block, a guiding block, and a press-fit screw, the driving block has a first inclined guiding surface and a through hole for passing through the first inclined guiding surface, the through hole has inner threads, the guiding block has a second inclined guiding surface and a guiding hole for passing through the second inclined guiding surface, the first inclined guiding surface and the second inclined guiding surface are respectively formed a tapered side toward the corresponding receiving groove and a divergent side opposite to the tapered side, the press-fit block includes a trepanning hole, a press-fit surface, and two inclined end surfaces respectively corresponding to the first inclined guiding surface and the second inclined guiding surface, a diameter of the trepanning hole is larger than a diameter of the press-fit screw and passed through the two end surfaces, the press-fit screw is passed through the guiding hole and the trepanning hole and screwed with the inner threads of the driving block, the press-fit screw is screwed in so that the first inclined guiding surface and the second inclined guiding surface are respectively pressed-fit the two end surfaces of the press-fit block, the press-fit surface of the press-fit block is moved toward the font-fork hole and then pressed-fit a font fork and moved toward to handlebar hole to press-fit a handlebar, and the press-fit screw is screwed out so that the press-fit surface of the press-fit block is moved reversely to release.

2. The press-fit device for bicycle stein as claimed in claim 1, wherein a step groove is concavely arranged at the main body for fluidly communicating with an upper end of the front-fork hole and an upper end of the receiving groove fluidly communicated with the front-fork hole.

3. The press-fit device for bicycle stein as claimed in claim 1, wherein a support plate is arranged at a lower end of the receiving groove fluidly communicated with the front-fork hole and extended toward the front-fork hole to support the driving block.

4. The press-fit device for bicycle stein as claimed in claim 2, wherein a support plate is arranged at a lower end of the receiving groove fluidly communicated with the front-fork hole and extended toward the front-fork hole to support the driving block.

5. The press-fit device for bicycle stein as claimed in claim 2, wherein the main body has an upper cover for covering the step groove, the upper cover has two operation holes respectively corresponding to the front-fork hole and the press-fit screw.

6. The press-fit device for bicycle stein as claimed in claim 1, wherein one side of each press-fit block opposite to the press-fit surface has an arc connection surface corresponding to an inner wall of the corresponding receiving groove.

7. The press-fit device for bicycle stein as claimed in claim 1, wherein the guiding block has a step hole arranged at the guiding hole for receiving a head portion of the press-fit screw.

8. The press-fit device for bicycle stein as claimed in claim 1, wherein an axial direction of the front-fork hole is corresponding to a longitudinal direction of the main body, an axial direction of the handlebar hole is corresponding to a lateral direction of the main body, the receiving groove fluidly communicated with the front-fork hole and the receiving groove fluidly communicated with the handlebar hole are arranged adjacent to the connection of the front-fork hole and the handlebar hole.
